(19) United States
(12) Patent Application Publication
(10) Pub. No.: US 2021/0343094 A1
(43) Pub. Date: Nov. 4, 2021

(54) COMBINATION LOCK AND NOTEBOOK USING THE SAME

(71) Applicant: SHENZHEN WEIFENGDA GRAFT GIFT CO., LTD, Shenzhen (CN)

(72) Inventor: Jun Xiang, Shenzhen (CN)

(21) Appl. No.: 16/908,671

(22) Filed: Jun. 22, 2020

(30) Foreign Application Priority Data
Apr. 30, 2020 (CN) 202010361163.8

(51) Int. Cl. G07C 9/00; E05B 65/00

(52) U.S. Cl. CPC G07C 9/00563; E05B 65/00

(57) ABSTRACT

The present application discloses a combination lock including a lock body and a lock hook controlled by the lock body so as to be locked into or separated from the lock body; the lock body includes a base, an upper cover connected to the base, and a latch mechanism and a control circuit board disposed in a cavity enclosed by the base and the upper cover, the control circuit board receives an external trigger signal and controls the latch mechanism to move, achieving locking into or separation from the lock hook. Compared with the prior art, a combination lock and a notebook using the same of the present application uses fingerprint or digital touch control to perform identification, and has the control circuit board to control the movement of the motor, which automatically drives the latch piece to unlock and lock the lock body and lock hook.

### CROSS REFERENCE TO RELATED APPLICATIONS

The present application claims priority of Chinese patent application No. 202010361163.8 filed on Apr. 30, 2020. The entire disclosure of the application is hereby incorporated by reference in its entirety.

### TECHNICAL FIELD

The present application relates to the technical field of notebooks, in particular to a fingerprint or digital touch control combination lock and a notebook using the same.

### BACKGROUND TECHNOLOGY

Notebooks are widely used office and study supplies. Conventional notebooks only have a writing function. In order to meet the needs for privacy protection, existing notebooks are also designed with a combination lock. However, the combination locks on existing notebooks are usually implemented by means of mechanical numerals or mechanical locks. The disadvantages of this method are that the mechanical lock is easy to be unlocked and disassembled, and anyone can open it knowing the password, hence it has a low security and fails to protect privacy.

### SUMMARY

An objective of the present application is to provide a combination lock and a notebook using the same, which overcomes the disadvantages of the prior art and solves the technical problems that the mechanical combination lock is easy to be disassembled and has low security.

In order to achieve the above objective, the present application adopts the following technical proposals:

A combination lock includes a lock body, and a lock hook controlled by the lock body so as to be locked into or separated from the lock body. The lock body includes a base, an upper cover connected to the base, and a latch mechanism and a control circuit board disposed in a cavity enclosed by the base and the upper cover, the control circuit board receives an external trigger signal and controls the latch mechanism to move, achieving locking or separation of the lock hook.

A slot with a removable USB disk is further provided on the lock body. The USB disk is provided with a through-hole which allows the lock hook to pass through, so that the USB disk can be taken out only if the combination lock is unlocked, which increases the safety of the USB disk.

Further, the latch mechanism includes a latch piece, a motor arranged on the latch piece, and an eccentric wheel connected to an output shaft of the motor, the motor is controlled by the control circuit board to drive the eccentric wheel to rotate, such that the latch piece is periodically pushed out or retracted, so as to be locked into and separated from the lock hook. The latch piece driven by the eccentric wheel has a simple structure and a low cost, and is easy to implement.

Further, the latch piece is further provided with a connecting pillar, the connecting pillar is arranged with an elastic member fixed to the base. The latch piece returns to its extended state under the action of the elastic member after being retracted. The elastic member is designed to ensure that the latch piece is in the extended state under natural state, and the lock can be locked as long as the lock hook is inserted.

Further, a digital password touch control module is provided on the control circuit board. The digital password touch control module can prevent disassembly as it can be automatically locked when the number of wrong inputs exceeds a preset value, while the mechanical combination lock cannot achieve this.

Further, a fingerprint module is provided on the control circuit board. The fingerprint combination lock further improves the security of the password lock. The combination lock can be only opened by the initially preset fingerprint hence its security is further improved compared with the digital password touch control module.

Further, the base is further arranged with a spring sheet located under a latch portion of the latch piece. When the lock hook is locked into the latch piece, the spring sheet is compressed, and when the latch piece is separated from the lock hook, the lock hook is automatically ejected from the lock body. The function of the spring sheet is to automatically eject the lock hook from the lock body when unlocking.

Further, the latch mechanism includes an upper casing, a lower casing connected to the upper casing, and a titanium or titanium alloy wire, a torsion spring and a latch arranged inside a cavity enclosed by the upper casing and the lower casing. An end of the titanium or titanium alloy wire is fixedly connected to the lower casing, and the other end is connected to the latch. The torsion spring is connected to a positioning column on the lower casing, an end of the torsion spring is connected to the lower casing, and the other end is connected to the latch. The titanium or titanium alloy wire is controlled by the control circuit board. When the titanium or titanium alloy wire is connected to power, it expands rapidly due to heat, and the torsion spring drives the latch to extend. On the contrary, when the titanium or titanium alloy wire is disconnected from power, it contracts rapidly under cooling and compresses the torsion spring so that the latch is retracted. Compared with the above-mentioned electrically driven eccentric wheel, applying the present latch mechanism may reduce the overall thickness of the latch mechanism, thereby realizing light weight and miniaturization of the combination lock.

Further, a plug connector is also inserted in the base, a pin of the plug connector passes through the base, and an end thereof is protruded from a bottom wall of the base.

A notebook includes a combination lock as described in any of the above which is connected to the notebook, the lock hook is connected to the upper casing of the notebook, and the lock body is connected to the lower casing of the notebook.

Compared with the prior art, the combination lock and the notebook using the same of the present application use fingerprint or digital touch control to perform identity recognition, and have a control circuit board to control the movement of the motor, which automatically drives the latch piece to lock and unlock the lock body and lock hook. The identification is unique and highly secure. Disassembly by violence will cause destruction of the combination lock hence improves protection of privacy.

The above description is merely an overview of the technical proposals of the present application. In order to understand the technical means of the present application more clearly, it can be implemented in accordance with the content of the specification, and in order to make the above and other objectives, features and advantages of the present application more obvious and to be more fully understood, the following preferred embodiments are described in detail below.

### BRIEF DESCRIPTION OF THE DRAWINGS

FIG. 1 is an overall structural view of the combination lock of the present application;

FIG. 2 is an exploded view of the combination lock of the present application;

FIG. 3 is a structural view of the lock hook of the present application;

FIG. 4 is a structural view of the latch mechanism and the control circuit board of the combination lock of the present application;

FIG. 5 is another structural view of the latch mechanism and the control circuit board of the combination lock of the present application;

FIG. 6 is a structural view of the upper cover of the combination lock of the present application;

FIG. 7 is a structural view of the base of the combination lock of the present application;

FIG. 8 is a structural view of the motor of the combination lock of the present application;

FIG. 9 is a structural view of the eccentric wheel of the combination lock of the present application;

FIG. 10 is a structural view of the USB disk of the combination lock of the present application;

FIG. 11 is a structural view of the fixing member of the combination lock of the present application;

FIG. 12 is a structural view of the latch piece of the combination lock of the present application;

FIG. 13 is a structural view of another embodiment of the latch piece of the combination lock of the present application;

FIG. 14 is a structural view of FIG. 13 viewed from another angle.

### DESCRIPTION OF THE EMBODIMENTS

In order to make the objectives, technical proposals and advantages of the present application clearer, the present application will be further described in detail below with reference to the accompanying drawings and detailed embodiments.

The technical proposals in the embodiments of the present application will be clearly and completely described in conjunction with the accompanying drawings in the embodiments of the present application. It is apparent that the described embodiments are merely part of the embodiments of the present application rather than all embodiments. Based on the embodiments of the present application, all other embodiments obtained by those skilled in the art without creative work fall within the scope of protection of the present application.

In the description of the present application, it should be understood that the terms “center”, “longitudinal direction”, “transverse direction”, “length”, “width”, “thickness”, “upper”, “lower”, “front”, ““rear”, “left”, “right”, “vertical”, “horizontal”, “top”, “bottom”, “inner”, “outer”, “clockwise”, “counterclockwise” etc. indicate spatial relationship that is based on the orientation or positional relationship shown in the drawings, and is only for the convenience of describing the application and simplifying the description, rather than indicating or implying that the device or element referred to must have a specific orientation and be constructed and operated in a specific orientation, therefore these cannot be understood as a limitation to the present application.

In addition, the terms “first” and “second” are used for descriptive purposes only, and cannot be understood as indicating or implying relative importance or implicitly indicating the number of technical features referred to. Therefore, the features defined as “first” and “second” may explicitly or implicitly include one or more of the features. In the description of the present application, the meaning of “plurality” is two or more, unless otherwise specified.

In the present invention, unless otherwise clearly specified and limited, the terms “installation”, “connected”, “connected”, “fixed” and other terms should be interpreted as broad meaning, for example, it may be connected or detachably connected, or formed into one entity; It may be a physical connection or electrical connection; it may be directly connected, or it may be indirectly connected through an intermediate medium; it may be an internal communication or interaction between two elements. Those skilled in the art can understand the specific meanings of the above terms in the present application according to specific situations.

In the present invention, unless otherwise clearly specified and defined, the first feature “above” or “below” the second feature may include the direct contact of the first and second feature, or may include the first and second features not in direct contact but through another feature therebetween. Moreover, the first feature is “on”, “above” and “over” the second feature includes that the first feature is directly above and obliquely above the second feature, or simply means that the first feature is higher in level than the second feature. The first feature is “under”, “below” and “underneath” the second feature includes that the first feature is directly below and obliquely below the second feature, or simply means that the first feature is lower in level than the second feature.

In the description of the present application, the description referring to the terms “one embodiment”, “some embodiments”, “examples”, “specific examples”, or “some examples” means the specific features, structures, materials or characteristics described in conjunction with the embodiment or examples is included in at least one embodiment or example of the present application. In the present application, the illustrative expression of the above terms should not be understood as having to refer to the same embodiment or example. Moreover, the specific features, structures, materials, or characteristics described may be combined in any suitable manner in any one or more embodiments or examples. In addition, those skilled in the art may bind and combine different embodiments or examples described in the present application.

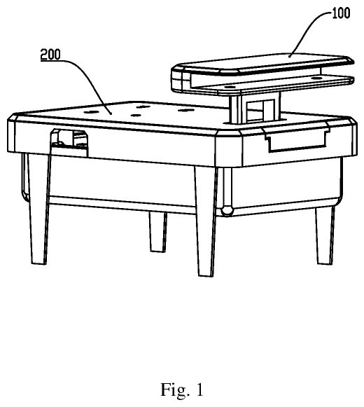

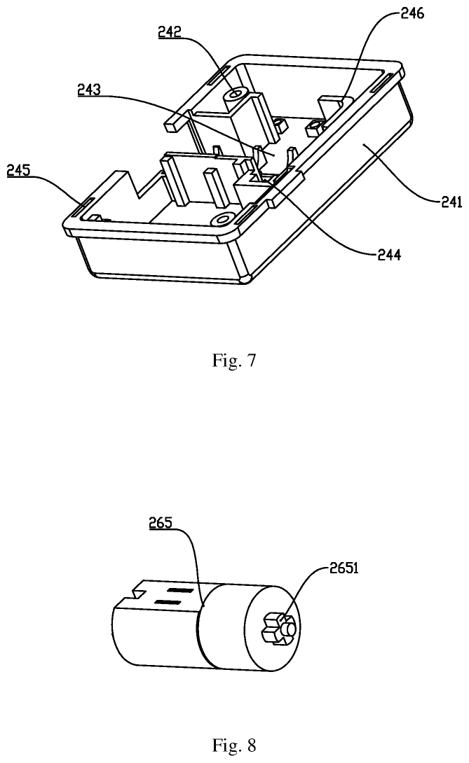

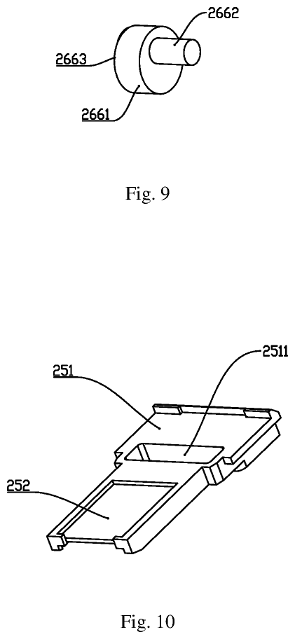

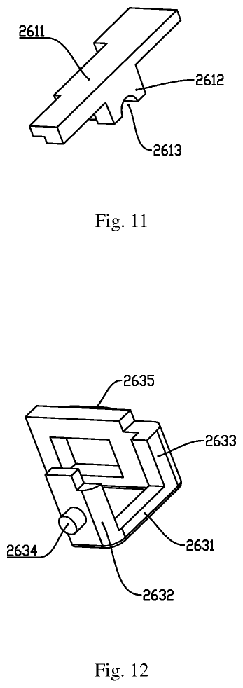

Referring to FIGS. 1 to 14, in the present embodiment, the embodiment of the present application provides a combination lock, which includes a lock body 200, and a lock hook 100 controlled by the lock body 200 so as to be locked into or separated from the lock body 200. In a specific application scenario, the lock body 200 and the lock hook 100 are respectively connected to a first casing and a second casing that can be opened and closed, such as the upper and lower casings of a notebook, folders, briefcases, and handbags etc.

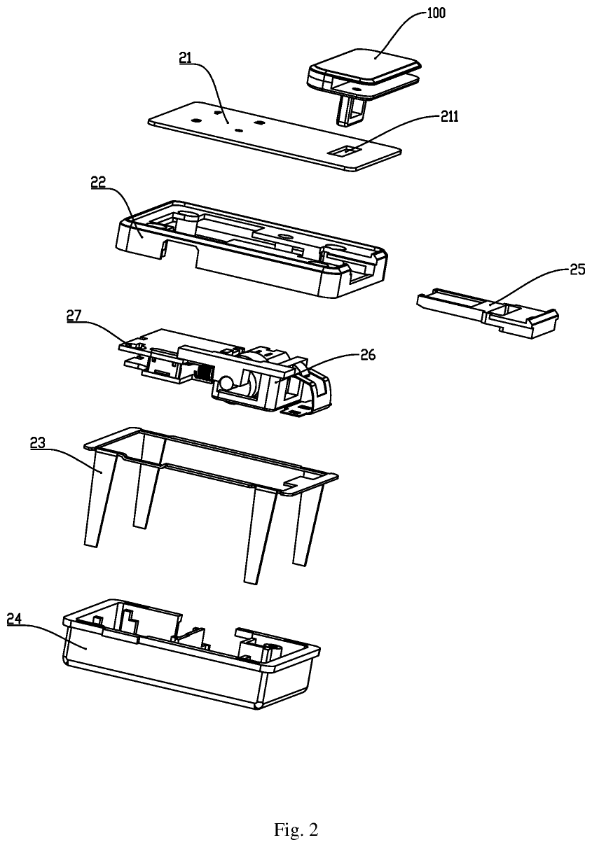

Referring again to FIG. 2, the lock body 200 includes a base 24, an upper cover 22 connected to the base 24, and a latch mechanism 26 and a control circuit board 27 disposed in a cavity enclosed by the base 24 and the upper cover 22. The control circuit board 27 receives an external trigger signal and controls the movement of the latch mechanism 26 to achieve locking or separation of the lock hook 100. The external trigger signal includes a fingerprint input signal or a digital touch pressure input signal. The top part of the upper cover 22 is also provided with a tempered glass plate 21, or it may also be an acrylic plate. When an acrylic plate is used, an opening is provided above the control circuit board 27. The tempered glass plate 21 has an opening 211 into which a lock buckle 12 of the lock hook 100 can be inserted. The tempered glass plate 21 is fixedly connected to the upper cover 22 by 3M glue. The upper cover 22 is also provided with a reset hole. By pressing a reset button below the reset hole with a needle or the like, the password can be set and reset.

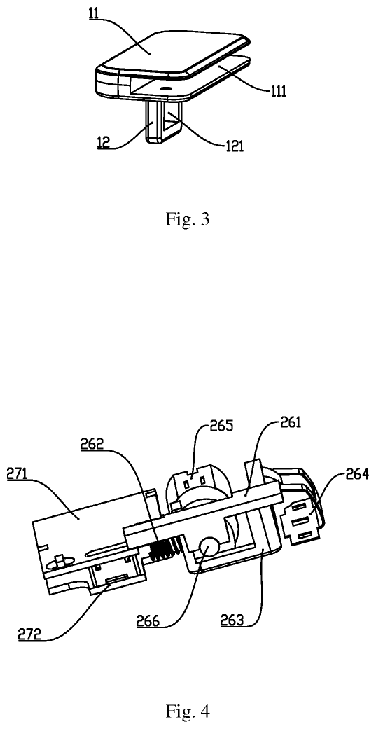

Referring again to FIG. 6, the lock body 200 is further provided with a slot 224 in which a removable USB disk 25 is inserted. In the present embodiment, the slot 224 is provided on the upper cover 22, while in other embodiments, it may also be provided on the base 24. Specifically, the USB disk 25 includes a USB disk holder 251, a memory chip 252 fixed on the USB disk holder 251, and a magnet (not shown in the drawing) embedded in the USB disk holder 251. The surface of the memory chip 252 on the USB disk holder 251 is also provided with an insulating film. Since the upper cover 22 or plug connector 23 is made of iron in the present embodiment, the magnet is provided on the USB disk 25 so as to magnetically attract to the upper cover 22 to improve the stability. Moreover, the USB disk holder 251 is provided with a through-hole 2511 for the lock hook 100 to pass through. Referring to FIG. 3, the lock hook 100 includes a lock hook body 11 and a lock buckle 12 extending vertically from the bottom surface of the lock hook body 11. The lock buckle 12 has a lock hole 121 which cooperates with a latch portion 2635 on a latch piece 263 to perform locking and unlocking. The lock hook body 11 is also provided with a locking slot 111 for connecting the lock hook 100 to the upper case of the notebook, and the side wall of the locking slot 111 is provided with a screw hole through which the lock hook 100 can be fixedly connected to a carrier such as a notebook. Furthermore, the lock buckle 12 can pass through the through-hole 2511 on the USB disk 25, and the USB disk 25 can be taken out only if the lock hook 100 is separated from the lock body 200. The USB disk 25 is locked in the upper cover 22 of the lock body 200, thus the security of the USB disk 25 is improved. Moreover, a side wall of the upper cover 22 is further provided with a USB socket 225, and a USB interface electrically connected to the control circuit board 27 is protruded from the USB socket 225, so as to be connected with an external cable.

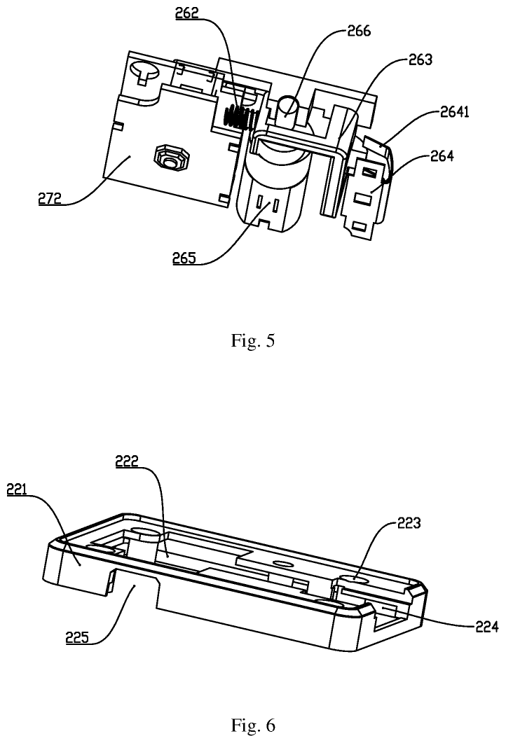

Referring to FIGS. 4 and 5 again, the latch mechanism 26 includes a latch piece 263, a motor 265 arranged on the latch piece 263, and an eccentric wheel 266 connected to an output shaft of the motor 265. The motor 265 is controlled by the control circuit board 27, and drives the eccentric wheel 266 to rotate, so as to periodically push the latch piece 263 to extend or retract, thereby locking to and separating from the lock hook.

As shown in FIG. 12, a connecting pillar 2634 is provided on the latch piece 263, and an elastic member 262 is arranged on the connecting pillar 2634. The elastic member 262 is fixed to the base 24, and after the latch piece 263 is controlled to retract, it is restored to the extended state under the action of the elastic member 262. In the present embodiment, the elastic member 262 is a spring.

Specifically, referring to FIGS. 6 to 12 again, the upper cover 22 includes an upper cover body 221. A slot 224 for inserting the USB disk 25 and a plurality of connecting holes 223 are provided on a top part of the upper cover body 221. A notch 222 for accommodating a signal input surface of a fingerprint module or a digital touch control password module is provided above the control circuit board 27 on the top part of the upper cover body 221. The base 24 connected to the upper cover 22 includes a base body 241 in a box-like shape with an opening at the top, which forms a complete box after being connected with the upper cover body 221. A plurality of connecting columns 242 corresponding to the connecting holes 223 are provided on a bottom wall of the base body 241. The upper cover 22 can be connected and fixed to the base 24 by screws. A motor mounting groove 243 for fixing the motor 265 and a fixing groove 244 for the elastic member 262 are also provided on the bottom wall of the base body 241. A plurality of through-holes 245 for the plug connector 23 to pass through are provided on the side wall of the base body 241. An upper part of the plug connector 23 is fixed between the upper cover 22 and the side wall of the base 24, and a lower end part is protruded beyond the bottom wall of the base 24, so as to be fixedly connected to a carrier such as a notebook casing. Furthermore, a limiting plate 246 extending upward is provided on the bottom wall of the base body 241, which cooperates with the latch piece 263 so that the latch piece 263 moves laterally back and forth within the base 24.

As shown in FIG. 12, the latch piece 263 includes a connecting portion 2631, and a first side wall 2632 and a second side wall 2633 extending upward from both ends of the connecting portion 2631. The motor 265 is accommodated in the space between the first side wall 2632 and the second side wall 2633, and the eccentric wheel 266 is also located between the first side wall 2632 and the second side wall 2633. Furthermore, the first side wall 2632 is provided with the connecting pillar 2634, and the second side wall 2633 is provided with the latch portion 2635. As shown in the figure, in the present embodiment, the latch piece 263 extends and retracts horizontally to cooperate with the lock buckle 12 of the lock hook 100 that moves vertically upward and downward to achieve locking or unlocking. The U-shaped space formed between the first side wall 2632 and the second side wall 2633 is fitted with the limiting plate 246 so that the latch piece 263 extends and retracts in the direction defined by the limiting plate 246.

In this embodiment, a cross-shaped connecting block 2651 is connected to the output shaft of the motor 265, and a cross-shaped groove 2663 corresponding to the cross-shaped connecting block 2651 is provided on the eccentric wheel 266. Specifically, the eccentric wheel 266 includes a disc portion 2661, a supporting pillar 2662 connected to one side of the disc portion 2661 at a position away from the center, and a cross-shaped groove 2663 provided on the other side of the disc portion 2661. Since the top part of the latch piece 263 is not in connection, in order to ensure the stability of the assembly of the motor 265 and the eccentric wheel 266, an eccentric wheel fixing member 261 is provided. The eccentric wheel fixing member 261 includes a plate portion 2611, and a clamping portion 2612 protruding from a lower bottom surface of the plate portion 2611, and the clamping portion 2612 is provided with a semi-circular groove 2613 that cooperates with the supporting pillar 2662 of the eccentric wheel 266 to mount the eccentric wheel 266 onto the base 24. In other embodiments, the supporting pillar 2662 may be rotatably connected to the side wall of the base 24 so that the eccentric wheel fixing member 261 may be omitted.

Referring again to FIGS. 4 and 5, in the present embodiment, the control circuit board 27 is further provided with a digital password touch control module or a fingerprint module 271, the digital password touch control module or the fingerprint module is controlled by a control module 272. The control module 272 is provided with a controller, such as an MCU, for processing the signals received by the digital password touch control module or fingerprint module 271 and carrying out determination, and at the same time outputting control commands to the motor 265 to control its opening and closing actions. Of course, considering that controllers such as MCUs themselves have communication functions, the combination lock can also communicate with mobile terminals such as mobile phones to perform remote positioning, unlocking, report of loss or password modification.

Furthermore, a spring sheet 264 is arranged in the base 24, and the spring sheet 264 is located under the latch portion 2635 of the latch piece 263. The spring sheet 264 is compressed when the lock hook 100 and the latch piece 263 are locked, and the lock hook 100 is automatically ejected from the lock body 200 when the latch piece exits the lock hook 100. Specifically, the spring sheet 264 is provided with a U-shaped spring sheet end 2641 which is spanned over the latch portion 2635, and is in abutment against the lock buckle 12 of the lock hook 100 when the lock hook 100 is locked, thereby achieving automatic ejection.

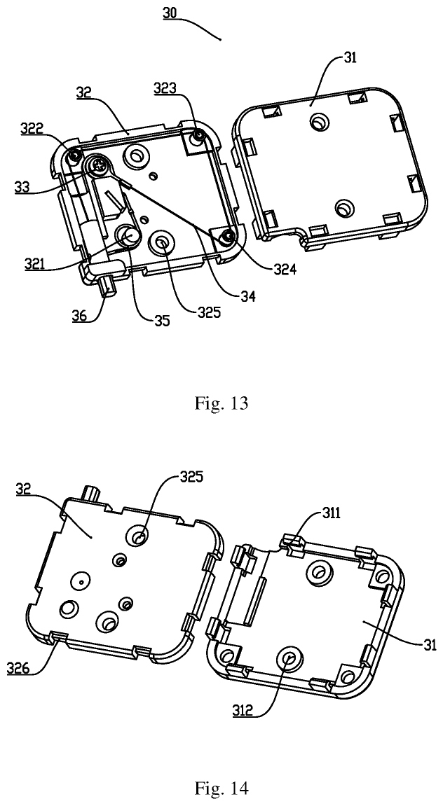

Referring again to FIGS. 13 and 14, which is a latch mechanism 30 according to another embodiment. In this embodiment, the latch mechanism 30 includes an upper casing 31, a lower casing 32 connected to the upper casing 31, a titanium or titanium alloy wire 34, a torsion spring 35 and a latch 36 arranged inside a cavity enclosed by the upper casing 31 and the lower casing 32. An end of the titanium or titanium alloy wire 34 is fixedly connected to the lower casing 32, and the other end is connected to the latch 36. The torsion spring 35 is connected to a positioning column 321 on the lower casing 32, an end of the torsion spring 35 is connected to the lower casing 32, and the other end is connected to the latch 36. The titanium or titanium alloy wire 34 is controlled by the control circuit board 27. When the titanium or titanium alloy wire 34 is connected to power, it expands rapidly due to heat, and the torsion spring 35 drives the latch 36 to extend. On the contrary, when the titanium or titanium alloy wire 34 is disconnected from power, it contracts rapidly under cooling and compresses the torsion spring 35 so that the latch 36 is retracted.

Specifically, the upper casing 31 and the lower casing 32 are connected by snap-fitting. Snaps 311 are provided on peripheral edges of the upper casing 31, and snapping grooves 326 corresponding to the snaps 311 are provided on the lower casing 32. As shown in FIG. 13, one end of the titanium or titanium alloy wire 34 is fixedly connected to the lower casing 32 through a screw 33, and its middle part is tensioned passing around rotating sleeve members 324, 323 and 322 which are protruded from the bottom wall of the lower casing 32. The rotating sleeve members 322, 323 and 324 are respectively disposed at three corners of the lower casing. Specifically, the rotating sleeve members 322, 323 and 324 are all tube-like members sleeved on fixed columns to reduce the resistance when the titanium or titanium alloy wire 34 expands and contracts. The upper casing 31 is further provided with connecting holes 312, and the lower casing 32 is provided with connecting holes 325 corresponding to the upper casing 31. The latch mechanism 30 is fixedly mounted on the base 24 of the lock body 200 by screws and the like.

A notebook is also disclosed in the present embodiment, which includes a combination lock as described in any of the above, the lock hook is connected to an upper casing of the notebook, and the lock body is connected to a lower casing of the notebook. The above-mentioned combination lock can also be used for luggage, men's and women's bags, packaging boxes, wooden boxes, jewelry boxes, handbags, suitcases, cosmetic cases, cosmetic bags, and other private products.

Compared with the prior art, the combination lock and the notebook using the same of the present embodiment use fingerprint or digital touch control to perform identity recognition, and have a control circuit board to control the movement of the motor, which automatically drives the latch piece to lock and unlock the lock body and lock hook. The identity recognition via fingerprint and digital touch control combination lock is unique and highly secure. Disassembly by violence will cause destruction of the combination lock hence improves protection of privacy.

The above uses examples merely to further illustrate the technical content of the present application to facilitate easier understanding of the reader, but does not intend to limit the embodiments of the present application. Any technical extension or re-creation made according to the present application falls within the scope of the present application. The scope of protection of the present application should be defined in accordance with the appended claims.

What is claimed is:

1. A combination lock comprising:
a lock body; and
a lock hook, the lock hook being controlled by the lock body so as to be locked into or separated from the lock body,
wherein the lock body comprises:
a base;
an upper cover connected to the base; and
a latch mechanism and a control circuit board disposed in a cavity enclosed by the base and the upper cover,
wherein the control circuit board receives an external trigger signal and controls the latch mechanism to move, achieving locking or separation of the lock hook.

2. The combination lock according to claim 1,
wherein a slot is provided on the lock body, and a removable USB disk is disposed therein.

3. The combination lock according to claim 1, wherein the latch mechanism comprises:
a latch piece;
a motor located on the latch piece; and
an eccentric wheel connected to an output shaft of the motor,
the motor is controlled by the control circuit board to drive the eccentric wheel to rotate, such that the latch piece is periodically pushed out or retracted, so as to be locked into and separated from the lock hook.

4. The combination lock according to claim 3,
wherein the latch piece is further provided with a connecting pillar, the connecting pillar is provided with an elastic member fixed to the base, the latch piece returns to its extended state under an action of the elastic member after being retracted.

5. The combination lock according to claim 4,
wherein a digital password touch control module is provided on the control circuit board.

6. The combination lock according to claim 4,
wherein a fingerprint module is provided on the control circuit board.

7. The combination lock according to claim 4,
wherein the base is further provided therein with a spring sheet located under a latch portion of the latch piece, when the lock hook is locked into the latch piece, the spring sheet is compressed, and when the latch piece is separated from the lock hook, the lock hook is automatically ejected from the lock body.

8. The combination lock according to claim 1, wherein the latch mechanism comprises:
an upper casing;
a lower casing connected to the upper casing; and
a titanium or titanium alloy wire, a torsion spring and a latch arranged inside a cavity enclosed by the upper casing and the lower casing,
wherein an end of the titanium or titanium alloy wire is fixedly connected to the lower casing, and the other end is connected to the latch, the torsion spring is connected to a positioning column on the lower casing, an end of the torsion spring is connected to the lower casing, and the other end is connected to the latch, the titanium or titanium alloy wire is controlled by the control circuit board, the titanium or titanium alloy wire expands rapidly due to heat when being connected to power, and the torsion spring drives the latch to extend, and the titanium or titanium alloy wire contracts rapidly under cooling when being disconnected from power and compresses the torsion spring so that the latch is retracted.

9. The combination lock according to claim 3,
wherein a plug connector is inserted in the base, a pin of the plug connector passes through the base with an end thereof protruded from a bottom wall of the base.

10. A notebook comprising the combination lock according to claim 1,
wherein the lock hook is connected to an upper casing of the notebook, and the lock body is connected to a lower casing of the notebook.

11. The notebook according to claim 10,
wherein a slot is provided on the lock body, and a removable USB disk is disposed therein.

12. The notebook according to claim 10, wherein the latch mechanism comprises:
a latch piece;
a motor located on the latch piece; and
an eccentric wheel connected to an output shaft of the motor,
the motor is controlled by the control circuit board to drive the eccentric wheel to rotate, such that the latch piece is periodically pushed out or retracted, so as to be locked into and separated from the lock hook.

13. The notebook according to claim 12,
wherein the latch piece is further provided with a connecting pillar, the connecting pillar is provided with an elastic member fixed to the base, the latch piece returns to its extended state under an action of the elastic member after being retracted.

14. The notebook according to claim 13,
wherein a digital password touch control module is provided on the control circuit board.

15. The notebook according to claim 13,
wherein a fingerprint module is provided on the control circuit board.

16. The notebook according to claim 13,
wherein the base is further provided therein with a spring sheet located under a latch portion of the latch piece, when the lock hook is locked into the latch piece, the spring sheet is compressed, and when the latch piece is separated from the lock hook, the lock hook is automatically ejected from the lock body.

17. The notebook according to claim 10, wherein the latch mechanism comprises:
an upper casing;
a lower casing connected to the upper casing; and
a titanium or titanium alloy wire, a torsion spring and a latch arranged inside a cavity enclosed by the upper casing and the lower casing,
wherein an end of the titanium or titanium alloy wire is fixedly connected to the lower casing, and the other end is connected to the latch, the torsion spring is connected to a positioning column on the lower casing, an end of the torsion spring is connected to the lower casing, and the other end is connected to the latch, the titanium or titanium alloy wire is controlled by the control circuit board, the titanium or titanium alloy wire expands rapidly due to heat when being connected to power, and the torsion spring drives the latch to extend, and the titanium or titanium alloy wire contracts rapidly under cooling when being disconnected from power and compresses the torsion spring so that the latch is retracted.

18. The notebook according to claim 12,
wherein a plug connector is inserted in the base, a pin of the plug connector passes through the base with an end thereof protruded from a bottom wall of the base.
